(19) United States
(12) Patent Application Publication
(10) Pub. No.: US 2012/0227046 A1
(43) Pub. Date: Sep. 6, 2012

(54) METHOD AND APPARARTUS FOR MONITORING USAGE PATTERNS BY UTILIZING WINDOW TITLES

(75) Inventor: Sang Ho Park, Daejeon (KR)

(73) Assignee: JIRANSOFT CO., LTD., Daejeon (KR)

(21) Appl. No.: 13/510,199

(22) PCT Filed: Sep. 14, 2010
(86) PCT No.: PCT/KR2010/006257

§ 371 Date: May 16, 2012

(30) Foreign Application Priority Data
Jan. 6, 2010 (KR) 10-2010-0000823

(51) Int. Cl. G06F 9/46

(52) U.S. Cl. 718/100

(57) ABSTRACT

Disclosed are a method and apparatus for monitoring usage patterns by utilizing window titles. A method for monitoring a usage pattern by utilizing window titles according to an aspect of the invention, where the method is to be performed by a computing apparatus for monitoring a usage pattern of application programs, includes: acquiring a title of a window when an application program is executed to generate the window; recognizing window detail information associated with the title by referencing comparative data, and generating or renewing usage history information of the application program to correspond to the window detail information; and monitoring a usage pattern according to a set criterion by using the usage history information stored in correspondence to each application program.

### TECHNICAL FIELD

The present invention relates to a method for monitoring usage patterns on a computer, more particularly to a method and apparatus for monitoring usage patterns on a user's computer by utilizing window titles associated with the application programs used.

### BACKGROUND ART

Nowadays, computers are found not just at the workplace, but at most homes. The vast majority of people use computers to access the Internet or for work. In particular, most office workers use computers for their work. Various application programs, including word processing programs such as Hanword, Microsoft Word, etc., and business application programs such as PowerPoint, etc., as well as Internet search programs (web browsers) for accessing the Internet such as Explorer, FireFox, etc., are utilized on computing apparatuses.

Due to the plethora of application programs currently available, an increasing number of workers are using non-work related application programs for personal use, such as Messenger, etc., even during office hours. In particular, there is an increasing number of workers who use web browsers such as Explorer from Microsoft to access websites such as Internet shopping malls, online news sites, etc., as a result of which many companies have started monitoring and controlling their workers' Internet accesses. For example, some companies may prevent access to certain sites, such as Cyworld (www.cyworld.co.kr), during office hours, by monitoring the communication data of the in-house network and blocking Internet communications using the URLs (uniform resource locators) of the corresponding websites.

While it was possible to simply block access to certain sites using the Internet URLs, it was not easy to carefully monitor what operations, i.e. programs, the users are running on their computers during office hours.

Of course, a log file of the programs used by a user may be generated, but obtaining from the log file a history of what programs the user used and what operations were performed may entail the inconvenience of having to meticulously analyze the raw data for the log file, and moreover, it may not be possible to find the usage patterns, regarding how the user used the programs and for how long.

Also, most existing techniques for monitoring usage uses the field drive area of the operating system's kernel. Thus, a new filter driver may be needed for each version of the operating system, which can be costly in terms of time and manpower.

Furthermore, the kernel is a system that connects and manages the basic devices for running a computer, and since compatibility is very important in the kernel area, there is a high risk of conflicts occurring in the operating system.

### DISCLOSURE

### Technical Problem

To resolve the problems above, an aspect of the present invention is to provide a method and apparatus for monitoring a history of the programs used by users and the operations performed with the programs, by utilizing the text-format window titles from among the various log data associated with the usage of computer application programs, without touching the operating system's kernel.

Another aspect of the present invention is to provide a method and apparatus for monitoring the computer usage patterns of a user by utilizing the windows' titles associated with the programs running, to analyze the program type, file name, website type, URL, operation time, etc.

Other objectives of the invention will be more clearly understood from the embodiments of the invention described below.

### Technical Solution

One aspect of the invention provides a method for monitoring a usage pattern by utilizing window titles, where the method is to be performed by a computing apparatus for monitoring a usage pattern of application programs, as well as a recorded medium having recorded thereon a program of instructions for performing this method. The method includes: acquiring a title of a window when an application program is executed to generate the window; recognizing window detail information associated with the title by referencing comparative data, and generating or renewing usage history information of the application program to correspond to the window detail information; and monitoring a usage pattern according to a set criterion by using the usage history information stored in correspondence to each application program.

Here, recognizing the window detail information can include recognizing an attribute of the application program, and recognizing the window detail information having a category corresponding to the attribute from text included in the title.

Any one or more of a time during which the window is running and a time during which the window is active can be used as the usage history information.

If the executed application program is a web browser, a site name of an accessed website can be recognized as the window detail information, and if the executed application program is a tool program, a file name can be recognized as the window detail information. Any one or more of a running time and a run number of a window associated with the site name or the file name can be monitored as a usage pattern.

If the executed application program is a web browser, a search keyword or news information can be extracted from text included in the title and can be used as the window detail information.

Also, by using the comparative data, a URL of the site name can be recognized and used as the window detail information.

Another aspect of the invention provides a computing apparatus for monitoring a usage pattern of application programs, where the computing apparatus includes: a program recognition unit configured to acquire a title of a window when an application program is executed to generate the window, and recognize window detail information associated with the title by referencing pre-set comparative data; a history management unit configured to generate or renew usage history information of the application program to correspond to the window detail information; and a pattern monitoring unit configured to monitor a usage pattern according to a set criterion by using the usage history information stored in correspondence to each application program.

Here, the program recognition unit can acquire program information, which conveys what kind of program the application program is, from an operating system or the title. If the executed application program is a web browser, a site name of an accessed website can be recognized as the window detail information, and if the executed application program is a tool program, a file name can be recognized as the window detail information.

The history management unit can use any one or more of a time during which the window is running and a time during which the window is active, as the usage history information.

Also, the computing apparatus can further include a communication module configured to back up information regarding the usage pattern on a main management server connected through a network.

### Advantageous Effects

According to certain embodiments of the invention, the usage pattern of application programs associated with the use of a computing apparatus can be monitored and provided according to program type, file name, website type, URL, operation time, etc., enabling the user to recognize this and more efficiently utilize the usage time of the computing apparatus, and thereby improving work efficiency.

Also, according to certain embodiments of the invention, a history of the programs used and the operations performed with the programs can be monitored using text-format window titles, from among the various log data associated with the use of computer application programs, so that there is no risk of problems caused by manipulating the operating system's kernel, and the usage pattern of the computing apparatus can be monitored without applying a load that may affect processing speed.

### DESCRIPTION OF DRAWINGS

FIG. 1 is a diagram schematically illustrating the overall system for monitoring the usage patterns of user terminals according to an embodiment of the invention.

FIG. 2 is a functional block diagram illustrating the composition of a user terminal according to an embodiment of the invention.

FIG. 3 is a flow diagram schematically illustrating a process for monitoring a usage pattern in a user terminal according to an embodiment of the invention.

FIG. 4 through FIG. 7 illustrate examples of windows used in the popular Windows operating system from Microsoft.

FIG. 8 illustrates an example of comparative data according to an embodiment of the invention.

FIG. 9 is a table illustrating examples of usage history information for a web browser program according to an embodiment of the invention.

FIG. 10 illustrates an example of a usage pattern monitored and displayed according to an embodiment of the invention.

### MODE FOR INVENTION

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention.

Certain embodiments of the invention will be described below in more detail with reference to the accompanying drawings. Those components that are the same or are in correspondence are rendered the same reference numeral regardless of the figure number, and redundant descriptions are omitted.

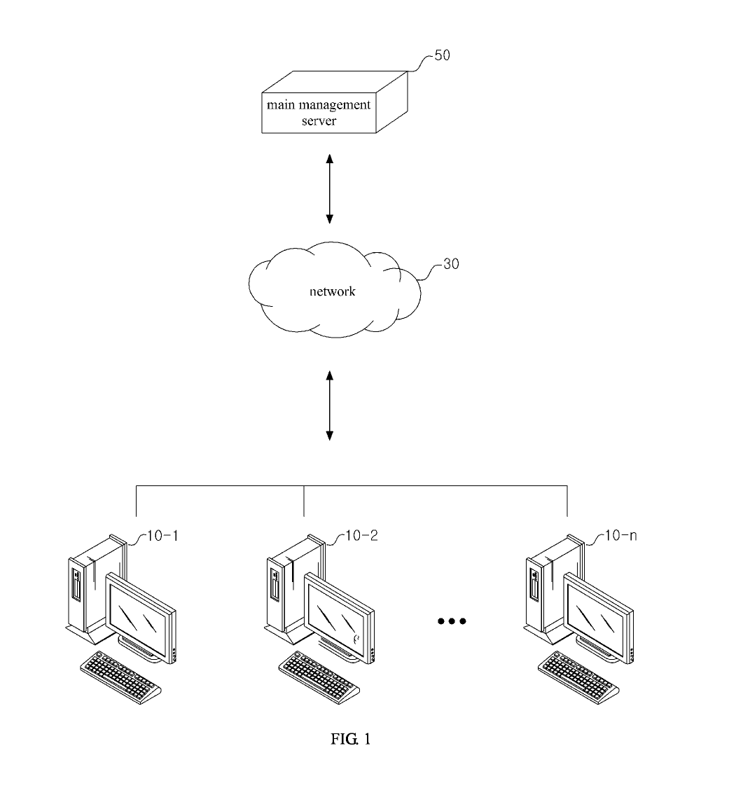

FIG. 1 is a diagram schematically illustrating the overall system for monitoring the usage patterns of user terminals according to an embodiment of the invention.

Referring to FIG. 1, the overall system according to this embodiment may include user terminals 10-1, 10-2, . . . 10-n (collectively referred to by 10), a network 30, and a main management server 50.

A user terminal 10 can be a regular computer, such as a desktop, laptop, etc., as well as any device equipped with computing functions, such as a smart phone, a personal digital assistant (PDA), etc.

The user terminals 10 according to this embodiment may be installed with a monitoring program. The monitoring program may be a program for managing usage history associated with the use of application programs such as web browsers, word processing programs, multimedia players (e.g. GOM Media Player, etc.) messenger programs (e.g. MSN Messenger, Nate Messenger, etc.), and the like, and analyzing usage history, to provide it to the user. The processing methods and detailed procedures will be described later on.

The main management server 50 may provide the above monitoring program through the network 30 to the user terminals 10. Of course, it is apparent that the monitoring program can be installed on a user terminal 10 by using a storage medium such as a CD, USB memory device, etc., or can be installed by downloading from the main management server 50.

Also, the main management server 50 may receive the usage histories and/or usage patterns described above from the multiple user terminals 10 connected by the network 30, and may provide an interface for inspection by an administrator.

For better understanding, consider an example in which the present system is established in a company. The monitoring program above can be installed on each worker's user terminal 10 and can periodically back up information related to its usage pattern on the main management server 50, allowing the administrator at the company to check the patterns by which each of the workers uses the user terminal 10.

The network 30 illustrated in the drawing can be a private network such as a LAN (local area network) or a public network such as the Internet.

A more detailed description will be provided below on the method of monitoring usage patterns, with reference to the components of the user terminal 10.

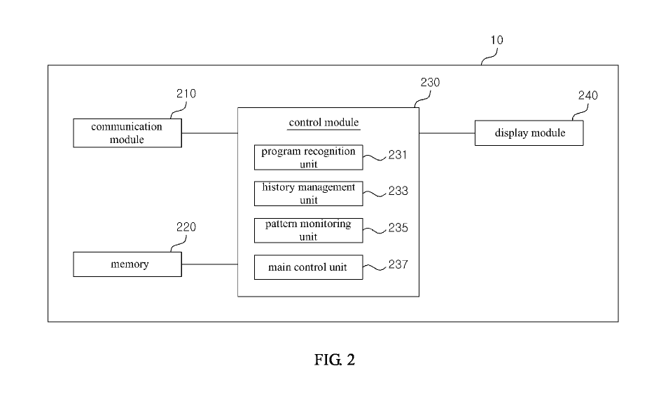

FIG. 2 is a functional block diagram illustrating the composition of a user terminal 10 according to an embodiment of the invention.

Referring to FIG. 2, a user terminal 10 according to this embodiment may include a communication module 210, a memory 220, a control module 230, and a display module 240.

The communication module 210 may be used for communicating with other communication devices, such as the main management server 50, through the network 30. This would be obvious to the skilled person and thus will not be described here in excessive detail.

The display module 240 may be used for displaying a user interface (UI) screen including information on the analyzed usage patterns, and for example, can be an LCD.

The memory 220 may store information required by the control module 230 for monitoring the user's usage pattern. As will be described later in more detail, the memory 220 may store comparative data required by the control module 230 for recognizing from the window titles what file name an executed application program has or which website is accessed. Of course, other information on various application programs, such as the monitoring program described above, executed by the user terminal 10 can be stored on the memory 220.

The control module 230 can include a program recognition unit 231, a history management unit 233, a pattern monitoring unit 235, and a main control unit 237. Here, it is apparent to the skilled person that each functional unit of the control module 230 can be implemented by software means, for example by programs.

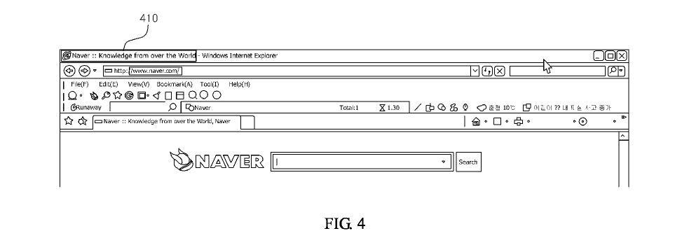

When a window (referring to a window used in the graphic user interface (GUI) of a computer) is activated as a particular program is executed, the program recognition unit 231 may recognize what program it is, i.e. recognize the type of the executed program, and may acquire the title of the window to recognize the detailed information (hereinafter referred to as window detail information) of the window generated by the execution of the program. Here, the window detail information can include the site name of an accessed website or a file name and running time, etc. (see FIGS. 4 to 6) A more detailed description will be provided later on.

The program recognition unit 231 may acquire program information regarding the executed application program, where the program information can include not only the information on the type of program, but also attribute information regarding what function the program is for, such as document processing, or web browser, etc. Here, it is apparent that the program recognition unit 231 can acquire the program information from the operating system, but according to another embodiment, the program information can also be acquired from the window titles. As will be described later on, a window title may include information on what kind of program the executed program is (see FIGS. 4 to 7), and thus the program recognition unit 231 can acquire the program information from the window title.

The history management unit 233 may generate or renew the usage history information associated with the window detail information recognized as an application program is executed, such that the usage history information corresponds to each application program. The usage history information can include time information related to when the program began running, time information related to how long the program was maintained, time information related to the duration of the actually active state (i.e. how long the corresponding window was placed in the foreground), run number information related to how many times the application program was executed, etc., in addition to the window detail information described above.

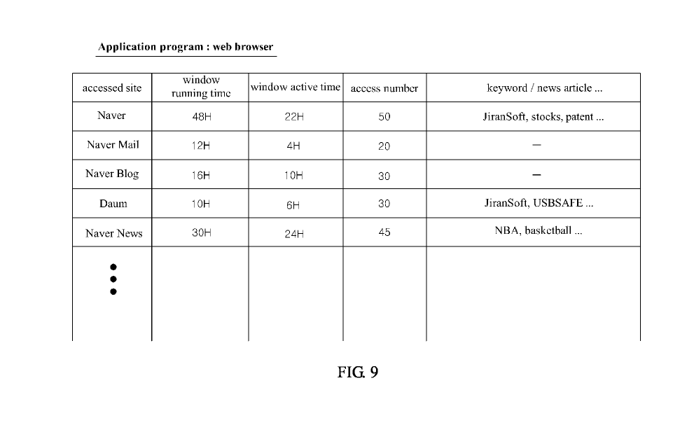

FIG. 9 is a table illustrating examples of usage history information for a web browser program according to an embodiment of the invention.

Referring to FIG. 9, the history management unit 233 may generate and renew the usage history information of application programs such as web browsers, including the name of the website accessed, the running time of the window generated in accordance with the running of the program, the time during which the window was active, the number of accesses to the website, the keywords inputted at the website, and the like. Among the many fields of usage history information illustrated in the drawing, the accessed website and keyword fields may be acquired from the window titles, as described above. Of course, for the other fields, the above time information can be obtained by an application program installed on the user terminal 10 that counts time, and for the number information, a separate field can be generated for counting the number of times the application programs (or their corresponding windows) are executed.

Here, the window running time refers to the time during which a window generated by an execution of a corresponding program is maintained without closing. If a multiple number of windows are run due to multitasking, the window running in the foreground is said to be in an active state, and the time during which a window is kept in an active state is defined as the active time.

Referring again to FIG. 2, the pattern monitoring unit 235 may monitor usage patterns by using the usage history information obtained by the history management unit 233. That is, the pattern monitoring unit 235 may gather the usage history information for executions of each program and calculate usage patterns for a certain period of time. For example, the run number of a web browser, the accessed page/number of accesses/duration of access/keywords inputted, etc., for each accessed website may be stored as usage history information of the web browser program, and based on the usage history information of each of the programs, such as the examples of usage history information described above, the pattern monitoring unit 235 may calculate usage patterns, such as the usage time of each program as compared to the total usage time, and the like. Of course, the usage history information of each program can itself be a usage pattern, but the usage history information and the usage pattern are differentiated in the definitions and descriptions for easier explanation and easier understanding, as a user may want to check usage histories as compared to the total time or for a period of time set by the user.

The main control unit 237 may control the program recognition unit 231, history management unit 233, and pattern monitoring unit 235 in such a way that enables the control module 230 to run a certain program, generate or renew usage history information of the executed program, and monitor usage patterns by using the usage history information.

While this embodiment was briefly described with respect to the functions of each component of a user terminal 10 performing the usage pattern monitoring, the following descriptions of the process for monitoring usage patterns will further clarify how each component of the user terminal 10 functions.

Although this embodiment is described using an example in which the user terminal 10 monitors the user's usage patterns by itself, other embodiments can also involve processing with linkage to the main management server 50. For example, the comparative data can be stored in the main management server 50, and the recognition of window detail information associated with the window titles can be performed by the main management server 50, with the corresponding information provided to the corresponding user terminal 10. Alternatively, the usage history information can also be stored in the main management server 50, and the user terminal 10 can receive the usage history information and display the information on usage patterns through the display module 240.

Having a single user terminal 10 process a particular function by itself or having the processing performed in linkage with other devices connected through the network 30 as described above is obvious to the skilled person and thus redundant descriptions will be omitted. For easier explanation, however, the following descriptions will be provided assuming an example in which the user terminal 10 analyzes and monitors the usage patterns by itself and the corresponding information is stored as back-up in the main management server 50.

The process by which a user terminal 10 uses window titles as described above to generate or renew usage history information associated with each window activated by an executed program and thus monitor usage patterns will be described below in more detail.

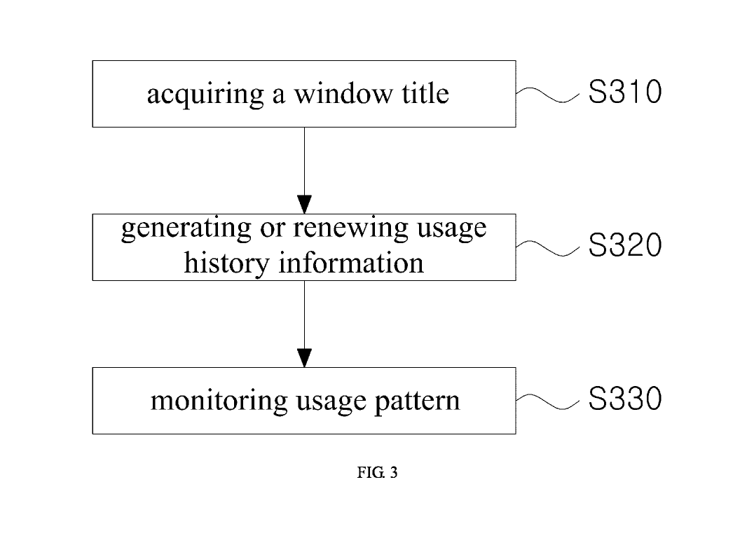

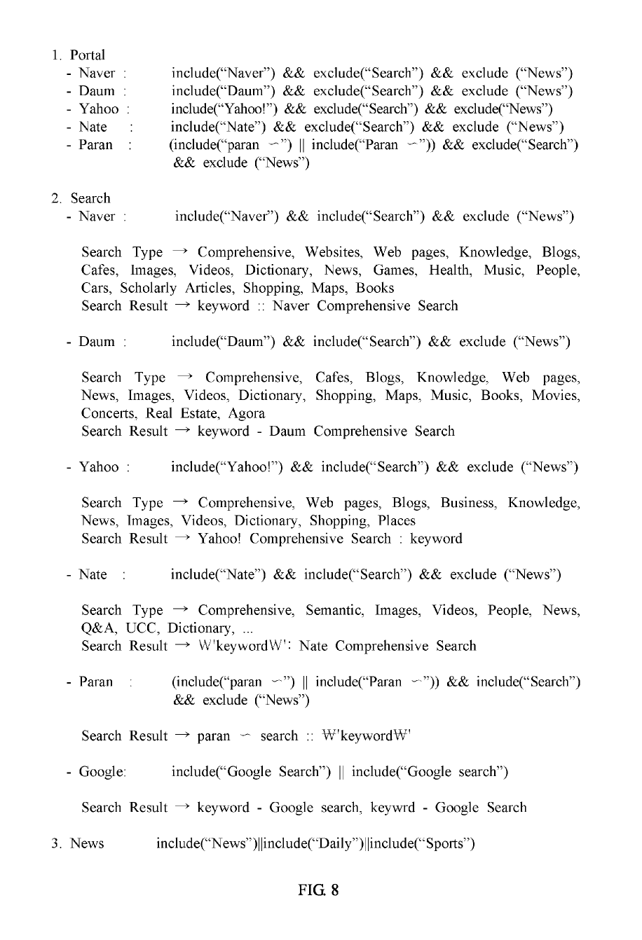

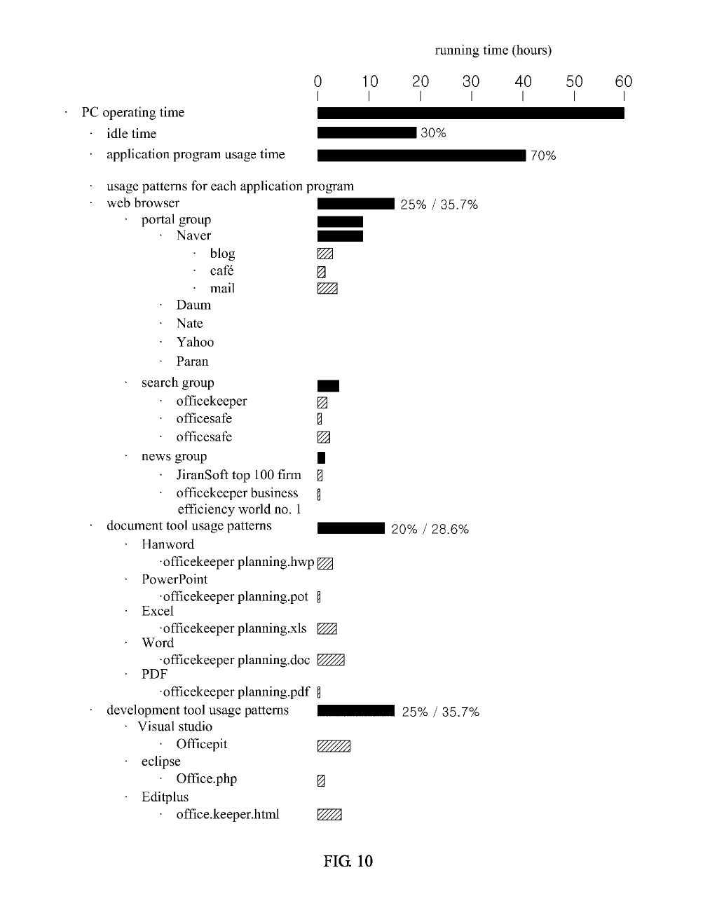

FIG. 3 is a flow diagram schematically illustrating a process for monitoring a usage pattern in a user terminal 10 according to an embodiment of the invention, FIG. 4 through FIG. 7 illustrate examples of windows used in the popular Windows operating system from Microsoft, FIG. 8 illustrates an example of comparative data according to an embodiment of the invention, and FIG. 10 illustrates an example of a usage pattern monitored and displayed according to an embodiment of the invention.

Referring first to FIG. 3, which illustrates a process of monitoring usage patterns, a method of monitoring usage patterns according to this embodiment may largely include acquiring a window title (S310), renewing the usage history information (S320), and monitoring the usage pattern (S330).

First, acquiring the window title is to acquire the tile of a window generated by a program being run. This can be acquired from the log data associated with the running of a particular program, or from an API (application programming interface) associated with the program, or by acquiring the text information associated with the window title using some other method. As this is obvious to the skilled person, further details will be omitted.

A typical window title may include a ‘text sequence’ and a ‘used program identification key.’ If the executed application program is a tool program such as Hanword, Microsoft Word, a multimedia player, etc., which generates or runs a particular file, the text sequence may include information on the name of the file run by the corresponding program. If the executed application program is a website access program, i.e. a web browser, the text sequence may include the name of the accessed website (the site name).

Also, program information, such as the type of the corresponding application program, can be recognized from the used program identification key in the window title.

Referring to FIG. 4, which illustrates a window that has been activated by running a web browser program according to an embodiment of the invention, the title of the window appears at the top of the window, as indicated by reference numeral 410. As described above, the corresponding window title includes the name of the website accessed by the web browser. Thus, by acquiring text information associated with the title of the generated window, the window detail information associated with the running of the program can be acquired.

Referring to FIG. 8, which illustrates an example of pre-stored comparative data, if the acquired window title includes the text ‘Naver,’ then comparison with the comparative data shows that the accessed website is Naver. Here, if the text of the window title does not include the words ‘Search’ and ‘News,’ then it can be recognized that the accessed website is the Naver portal, but if the word ‘Search’ or ‘News’ is included, then it can be recognized that the website is the Naver Search site or the Naver News site. Also, although it is not illustrated in the drawing, the access address (URL) of each website can be set as comparative data, to recognize the access address (i.e. www.naver.com) of the accessed site associated with the window title together with the window detail information.

Also, since the used program identification key included in the window title is ‘Microsoft Internet Explorer,’ it can be recognized that the corresponding application program is a web browser provided by Microsoft.

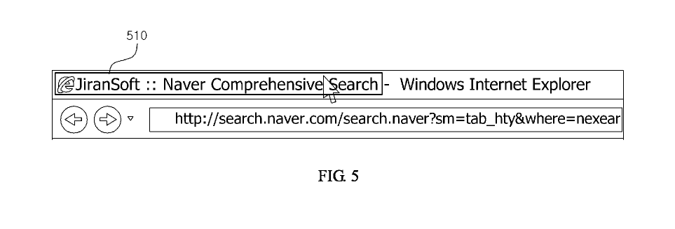

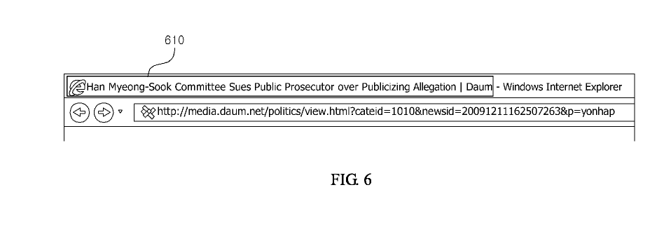

Also, according to FIG. 5 or FIG. 6, if a search is made or a news article is viewed at the accessed website, the corresponding search keyword or the news article title, etc., can be recognized from the window title (see reference numerals 510 and 610) and utilized as window detail information.

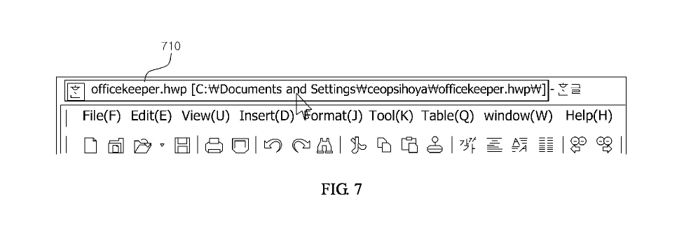

In the same or a similar manner, if a tool program such as a word processing program, etc., is used, it can be found from the window title what kind of program this is and what file was run. Referring to FIG. 7, it can be recognized from the window title (see reference numeral 710) that an application program for document processing named ‘Hanword’ was executed and that a file named ‘officekeeper.hwp’ was run, which can be used as window detail information.

Here, in the case of a tool program, such as a messenger program, which does not use a file and which therefore does not allow extraction of a file name from the window title, the name of the corresponding program and usage time can be used as the window detail information, or if a window such as a chat screen is activated, then the alias of the counterpart as shown on the window title can be used as window detail information. That is, the total usage time of the messenger program, the usage time of chatting screens for each alias, etc., can be used for the history information and usage pattern for each corresponding application program.

In summary, each application program executed may have its own attribute, and window detail information having different categories can be acquired according to the attribute. For example, Internet Explorer provided by Microsoft, FireFox, etc., are web browser programs and thus can have the attribute of Web Browser, while Microsoft Word, Hanword, Powerpoint, Excel, etc., can have the attribute of Document Processing. As another example, MSN Messenger, Nate Messenger, etc., can have the attribute of Messenger, for chatting with other people.

Each of the attributes above can have different categories of window detail information. For easier understanding, one example can have Web Browser using site name/search word/article title/running time, etc., as its window detail information categories, and can have Document Processing using program name/file title/running time, etc., as its window detail information categories.

Looking at FIG. 9 for example, if the attribute is Web Browser, the window detail information can include search keyword, blog owner ID, news article title, etc., as a detailed information category. Also, referring to FIG. 10, which will be described later in more detail, it will be obvious to the skilled person from the drawings that the window detail information having categories corresponding to the attribute of each application program can be used in monitoring the associated usage patterns.

Referring again to FIG. 3, renewing the usage history information (S320) may involve generating the usage history information of a corresponding application program, or if there already is usage history information generated previously, renewing the usage history information, by using the detailed information of the windows associated with the executed application programs, using the window titles. As described above, the usage history information may have several categories relating to the operations performed using the corresponding application programs, as illustrated in FIG. 9. That is, the time at which an application program began running, the time duration of maintaining the running, the duration of activation, window detail information, etc., may be stored as usage history information. As the details have already been described above, redundant descriptions will be omitted.

In one example, however, as the history information for an application program named Explorer, which is a web browser, the number of accesses, duration of access, the keywords used or news articles searched, etc., can be stored for each portal site, search site, and news site, as illustrated in FIG. 8.

The last step shown in FIG. 3, monitoring usage patterns (S330), may involve monitoring the usage patterns of the user terminal 10 based on the usage history information stored in association with the execution of each application program.

Referring to FIG. 10, which illustrates an example of a format for displaying the monitored information, the patterns associated with the usage history for each application program may be monitored. According to this embodiment, the usage patterns may be monitored for idle time (time during which there were no application programs executed) or the actual running times of the application programs, etc., in comparison to the total time the computer is operated.

For example, if the computer is operated for 60 hours, the idle time is 18 hours, and the program usage time is 42 hours as illustrated in the drawing, the pattern can be analyzed to show that application programs are in actual use during only about 60% of the time the computer is operated, and the usage patterns can be analyzed for usage times of a web browser, a document tool, or a development tool, etc.

In the present embodiment, the usage patterns may be monitored with the application programs classified according to the attributes of the application programs. For example, the application programs can be classified into web browsers, document tools, and development tools, and the total usage time, used filed names, searched keywords, articles, etc., can be indicated in the usage patterns, as illustrated in the drawing.

Also, as illustrated in the drawing, the time during which each application program was used can be displayed as a percentage of the total operating time or the total time of using application programs. With reference to the drawing, in one example, if the total usage time of web browsers is 15 hours, then its usage pattern can be analyzed as 25% of the total operating time, 35.7% of the total usage time of application programs. While it is not illustrated in the drawing, it is obvious that that the usage times for document processing programs can also be calculated and displayed for each file.

The method of monitoring usage patterns by utilizing window titles according to certain embodiments of the invention can be implemented on a computer-readable recorded medium as computer-readable code. Computer-readable recorded media may include all types of recorded media on which data is stored that can be read by a computer system. Examples may include ROM (read only memory), RAM (random access memory), magnetic tapes, magnetic disks, flash memory, optical data storage devices, etc. Also, the computer-readable recorded medium can be distributed across a computer system connected by a computer network, to be stored and executed as code that is read in a distributed manner.

While the present invention has been described with reference to particular embodiments, it is to be appreciated that various changes and modifications may be made by those skilled in the art without departing from the spirit and scope of the present invention, as defined by the appended claims and their equivalents.

1. A method for monitoring a usage pattern by utilizing window titles, the method performed by a computing apparatus for monitoring a usage pattern of application programs, the method comprising:
acquiring a title of a window when an application program is executed to generate the window;
recognizing an attribute of the application program according to a pre-set criterion, and recognizing window detail information having a category corresponding to the attribute by using text included in the title with reference to comparative data;
generating or renewing usage history information of the application program to correspond to the window detail information; and
monitoring a usage pattern according to a set criterion by using the usage history information.

2. The method of claim 1, wherein any one or more of a time during which the window is running and a time during which the window is active is used as the usage history information.

3. The method of claim 1, wherein a site name of an accessed website is recognized as the window detail information if the executed application program is a web browser, and a file name is recognized as the window detail information if the executed application program is a tool program.

4. The method of claim 1, wherein any one or more of a running time and a run number of a window associated with the site name or the file name is monitored as a usage pattern.

5. The method of claim 1, wherein a search keyword or news information is extracted from text included in the title and used as the window detail information, if the executed application program is a web browser.

6. The method of claim 1, wherein a URL of the site name is recognized using the comparative data and is used as the window detail information.

7. A recorded medium readable by a digital processing device, tangibly embodying a combination of instructions executable by the digital processing device for performing the method of claim 1.

8. A computing apparatus for monitoring a usage pattern of application programs, the computing apparatus comprising:
a program recognition unit configured to acquire a title of a window when an application program is executed to generate the window, recognize an attribute of the application program according to a pre-set criterion, and recognize window detail information having a category corresponding to the attribute by using text included in the title with reference to comparative data;
a history management unit configured to generate or renew usage history information of the application program to correspond to the window detail information; and
a pattern monitoring unit configured to monitor a usage pattern according to a set criterion by using the usage history information.

9. The computing apparatus of claim 8, wherein the program recognition unit acquires program information from an operating system or the title, the program information conveying what kind of program the application program is.

10. The computing apparatus of claim 8, wherein the program recognition unit recognizes a site name of an accessed website as the window detail information if the executed application program is a web browser and recognizes a file name as the window detail information if the executed application program is a tool program.

11. The computing apparatus of claim 8, wherein the history management unit uses as the usage history information any one or more of a time during which the window is running and a time during which the window is active.

12. The computing apparatus of claim 8, further comprising a communication module configured to back up information regarding the usage pattern on a main management server connected through a network.

13. A recorded medium readable by a digital processing device, tangibly embodying a combination of instructions executable by the digital processing device for performing the method of claim 3.

14. A recorded medium readable by a digital processing device, tangibly embodying a combination of instructions executable by the digital processing device for performing the method of claim 4.

15. A recorded medium readable by a digital processing device, tangibly embodying a combination of instructions executable by the digital processing device for performing the method of claim 5.

16. A recorded medium readable by a digital processing device, tangibly embodying a combination of instructions executable by the digital processing device for performing the method of claim 6.
